(19) United States
(12) Patent Application Publication
(10) Pub. No.: US 2025/0157483 A1
(43) Pub. Date: May 15, 2025

(54) Apparatus and Method for Quality Determination of Audio Signals

(71) Applicant: Fraunhofer-Gesellschaft zur Förderung der angewandten Forschung e.V., München (DE)

(72) Inventors: Pablo DELGADO, Erlangen (DE); Jürgen HERRE, Erlangen (DE)

(21) Appl. No.: 19/024,609

(22) Filed: Jan. 16, 2025

Related U.S. Application Data
(63) Continuation of application No. PCT/EP2023/078805, filed on Oct. 17, 2023.

(30) Foreign Application Priority Data
Oct. 20, 2022 (EP) 22202847.4

(51) Int. Cl. G10L 25/60

(52) U.S. Cl. CPC G10L 25/60

(57) ABSTRACT

An apparatus for quality determination of an audio signal according to an embodiment is provided. The apparatus comprises a perceptual model for receiving the audio signal and for determining distortion information for each of one or more distortion metrics, wherein each distortion metric of the one or more distortion metrics depends on a comparison between a feature of the audio signal and of a corresponding feature of reference information. Moreover, the apparatus comprises a distortion-to-quality mapping module for determining a quality of the audio signal depending on the distortion information for each of the one or more distortion metrics and depending on information on one or more cognitive effects.

### CROSS-REFERENCE TO RELATED APPLICATIONS

This application is a continuation of copending International Application No. PCT/EP2023/078805, filed Oct. 17, 2023, which is incorporated herein by reference in its entirety, and additionally claims priority from European Application No. 22202847.4, filed Oct. 20, 2022, which is also incorporated herein by reference in its entirety.

The present invention relates to quality determination of audio signals, to an apparatus and a method for quality determination of audio signals, and to a perception-based metric for perceived audio quality prediction and audio coding, and, in particular, to an improved metric of informational masking for perceptual audio quality measurement.

### BACKGROUND OF THE INVENTION

Audio coding is an emerging technical field, since the encoding and decoding of audio contents is important in many technical fields, like mobile communication, audio streaming, audio broadcast, television, etc.

In the following, an introduction to perceptual coding will be provided. It should be noted that the definitions and details discussed in the following can optionally be applied in conjunction with the embodiments disclosed herein.

Perceptual audio codecs like mp3 or AAC are widely used to code the audio in today's multimedia applications [1]. Most popular codecs are so-called waveform coders, that is, they preserve the audio's time domain waveform and mostly add (inaudible) noise to it due to perceptually controlled application of quantisation. Quantisation may typically happen in a time-frequency domain, but can also be applied in time domain [2]. To render the added noise inaudible, it is shaped under control of a psychoacoustic model, typically a perceptual masking model.

In today's audio applications, there is a constant request for lower bitrates. Perceptual audio codecs traditionally limit audio bandwidth to still achieve decent perceptual quality at these low bitrates. Efficient semi-parametric techniques like Spectral Bandwidth Replication (SBR) [3] in High Efficiency Advanced Audio Coding (HE-AAC) [4] or Intelligent Gap Filling (IGF) [5] in MPEG-H 3D Audio [6] and 3gpp Enhanced Voice Services (EVS) [7] are used for extending the bandlimited audio up to full bandwidth at decoder side. Such technique is called Bandwidth Extension (BWE). These techniques insert an estimate of the missing high frequency content controlled by a few parameters. Typically, the most important BWE side information is envelope related data. Usually, the estimation process is steered by heuristics rather than a psychoacoustic model.

Psychoacoustic models used in audio coding mainly rely on evaluating whether the error signal is perceptually masked by the original audio signal to be encoded. This approach works well when the error signal is caused by a quantisation process typically used in waveform encoders. For parametric signal representations, however, such as SBR or IGF, the error signal will be large even when artefacts are hardly audible.

This is a consequence of the fact that the human auditory system does not process the exact waveform of an audio signal; in certain situations the auditory system is phase insensitive and the temporal envelope of a spectral band becomes the main auditory information that is evaluated. For example, different starting phases of a sinusoid (with smooth onset and offsets) have no perceivable effect. For a harmonic complex tone, however, relative starting phases can be perceptually important, specifically when multiple harmonics fall within one auditory critical band [8]. The relative phases of these harmonics, as well as their amplitudes, will influence the temporal envelope shape that is represented within one auditory critical band which, in principle can be processed by the human auditory system.

One of the main goals of audio codec and audio processing algorithm development is to achieve the best possible sound quality within the given design parameters. Sound quality is one of the most important predictors of market acceptance of an audio codec and many other processing algorithms. Therefore, the assessment of perceived quality in a reliable manner is of utmost importance.

Listening tests are considered the golden standard for quality assessment. However, they take time and resources associated with listening equipment, listening subject training, response collection and statistical analysis that are not available at all times. Therefore, measurement equipment has been developed to estimate perceived quality of audio processing systems to approach listening test results. The measurement equipment makes use of computer algorithms to estimate audio quality. The use of automated algorithms for measuring quality can therefore save time and resources associated with the execution of listening tests.

An additional advantage of a quality metric is that audio coding and processing algorithms can potentially use this metric to internally adapt their operational parameters to optimize sound quality at different operational ranges with their associated constraints, e.g., bitrate, input signal characteristics, transmission channel conditions or complexity, etc.

Perceptual quality measurement systems (PQMS) algorithmically analyze the output of audio processing systems to estimate possible perceived quality degradation using perceptual models of human audition. In this manner, they save the time and resources associated with the design and execution of listening tests (LTs). Models of disturbance audibility predicting peripheral auditory masking in PQMS have considerably increased subjective quality prediction performance of signals processed by perceptual audio codecs. Additionally, cognitive effects have also been known to regulate perceived distortion severity by influencing their salience. However, the performance gains due to cognitive effects models in PQMS were inconsistent so far, particularly for music signals.

Many of the widely-adopted and standardized PQMS for perceptually coded audio signals use models of human auditory perception [15], [23]. Motivated by their successful use in perceptual audio codecs [24], most of these methods have so far focused on models of peripheral auditory masking and disturbance loudness around and above the masking threshold using energetic considerations [25], [26]. These metrics have been shown to strongly correlate with subjective degradation responses (i.e., grading annoyance or overall quality) in quality assessment tasks (see, e.g., [15], [21]).

In addition to disturbance loudness, other cognitive and central audition aspects regulate perceived distortion severity.

Newer PQMS incorporate, for example, modulation models for the evaluation of non-waveform preserving audio codecs [27]. In [19], Beerends proposed models for two important complementary cognitive phenomena in auditory perception: perceptual streaming (PS) and Informational Masking (IM).

The PS model works under the assumption that added signal components (i.e., distortions) present in the signal under test (SUT) will normally fail to form a common percept with the input signal. As a separate percept, the distortion component will be generally judged as more unpleasant by the listening subjects, as if the distortion formed a single percept with the signal. On the other hand, missing signal components will be less objectionable, as they will integrate into one single percept with the input signal more easily. The cognitive effect of IM can be expressed as an increase of the masking threshold due to masker complexity. In [19], the signal complexity is measured as the input signal's power deviation in time. The effects of PS and IM are thought to be complementary in that IM hinders the increase in perceived severity of a distortion due to PS. The IMPS (informational masking perceptual streaming) model in increased the prediction performance when added to a disturbance loudness distortion metric (DM). However, the performance gain in quality prediction of coded music signals was reported to be lower than in speech signals.

Most of the current objective quality assessment method (OQAM) use perceptual human auditory models to derive quality metrics. These methods specify the derivation of quality metrics by comparing perceptual representations (also called internal representations-IR) of the coded signals and a reference. An advantage of comparing processed and reference signals in the IR domain is, for example, the immunity to phase differences, as they are perceptually irrelevant [9]

The current OQAMs show limited performance in the quality prediction of parametrically coded audio signals.

There are multiple perceptual OQAM in the market/community, among others, such as VISQOL (see [11]), PEMO-Q (see [12]), POLQA (see [13]), PESQ (see [14]) and PEAQ (see [15]).

A coding artifact known as “tone trembling” is especially noticeable in signals with harmonic content that have been encoded using bandwidth extension (e.g., SBR) methods. It appears as a spurious tone modulating in time in the spectral envelopes. The coding errors (i.e. the difference between reference and coded signals) present predominantly a harmonic structure [20]. Quality metrics based on measurement of time envelope modulations, such as in [10], are meaningful for this kind of artifacts.

The analysis of other SBR mentioned errors in [20] is heavily based on the consideration of the signal tonality.

Particularly, the quality prediction of music signals and other signals with harmonic content that have been parametrically coded is still a challenge. Parametrically coded signals with harmonic content present certain distinctive distortion characteristics, specifically on signals with bandwidth extension techniques such as Spectral Band Replication:

An established perceptual OQAM for perceptually coded signals, PEAQ, has shown good quality prediction performance for non-parametric (waveform preserving) codecs. PEAQ is a multidimensional OQAM. A multidimensional OQAM combines multiple distortion metrics into a single quality score, describing overall perceived quality. FIG. 2 describes a functional diagram of such a multidimensional OQAM (more information on the underlying principles can be found in [15]):

FIG. 2 illustrates a scheme of a multidimensional objective quality assessment method (OQAM).

In FIG. 2, a reference signal and a signal under test (SUT, e.g., a coded signal) are processed by a perceptual model. A time-frequency decomposition is used to adapt the analysis to the frequency resolution of humans. The excitation pattern estimation applies models of auditory masking (temporal and frequency masking). The excitation patterns conform the internal representations of the signals. The multiple distortion metrics (DM) are derived from comparisons in the perceptual domain (i.e., using the internal representations of a perceptual model) between reference and coded signals. The distortion metrics can describe different aspects of quality degradation such as “disturbance loudness”, “noisiness”, “roughness”, “band limitation”, “errors with harmonic structure” and others. For example, a version of PEAQ uses the following distortion metrics (in PEAQ-called Model Output Values or MOVs):

TABLE 1

| | | Calculation |
|---|---|---|
| DM/MOV | Disturbance description | Method |
| AvgLinDist | Band Limitation | Filter Bank |
| RmsModDiff | Temporal Modulation of | Filter Bank |
| | disturbances (roughness) | |
| RmsNoiseLoud | Added noise in SUT | Filter Bank |
| RmsMissingComponents | Missing spectro-temporal | Filter Bank |
| | Components in SUT | |
| EHS | Harmonic structure of error | FFT |
| | (tonality of error) | |
| Segmental NMR | Noisiness, audibility of | FFT |
| | coding noise. | |

Table 1 relates to distortion metrics (MOVs) used in PEAQ. (see tables 4 and 17 in [15])

The distortion metrics can be averaged in frequency and time over the whole duration of the signals. Although shorter time windows can be used.

The different DMs describing different aspects of quality degradation are combined into a single (objective) quality score that predicts the mean subjective quality score of a human listener if the involved signals were presented in a listening test. The distortion metric-to-quality mapping stage is usually implemented as a multivariate regression algorithm that uses human listening test data as training data. E.g., Objective Quality Score=A*AvgLinDist+B*RmsModDiff+ . . . +higher order interactions. PEAQ uses, for example, Artificial Neural Networks (ANN) for the mapping. The combination of different DMs via a regression model supposes that the weight/importance that each DM will have in describing the overall objective score is determined by the training data and is fixed for the mapping model. The DM weights can be interpreted as the perceptual salience of the associated distortions [17]. For example, if AvgLinDist (average of the linear distortions) has a greater weight than RmsModDiff in a DM-to-quality mapping, it can be interpreted as: for the training data used, band limitations had a greater role in overall quality degradation than disturbance modulations (roughness). Therefore, band limitations were more salient than roughness distortions.

The performance of some of these OQAM when measuring the quality of parametric audio codecs has been unsatisfactory [18]. Particularly, the OQAM's quality metrics overestimate the perceived degradation when assessing the differences between an original waveform against its parametric representation when, in fact, the ear is less sensitive to these differences.

In [10], a psychoacoustic model to estimate a coded audio signal quality and to control coding parameters is disclosed. [10] describes an OQAM that according to [10] would provide a more accurate quality prediction of perceptual audio codecs that use non-waveform preserving (i.e., parametric) coding techniques. [10] presents an approach for quality measurement of parametrically coded signals that is based on the analysis of perceptual representations of the audio signals, specifically considering characterizations of temporal modulations of the audio signals as meaningful predictors of perceived audio quality in the case of parametric codecs. The modulation analysis model of the patent is more complex than that present in PEAQ. The OQAM presented in the patent is also unidimensional, no mapping of multiple distortion metrics to a single quality score is provided.

The analysis of signal modulations can be considered to model some central auditory processes to some extent. The analysis of signal modulations has been included in perceptual OQAM such as PEMO-Q and POLQA.

Most of the perceptual OQAMs try to predict perceived quality by estimating the audibility of signal disturbances (i.e., differences between coded and reference signal) using auditory masking models, and by estimating the perceived severity of said disturbances using loudness models based on the internal representations [16].

The masking and loudness models used in the OQAM are heavily based on peripheral aspects of human audition (i.e., processes happening in the human cochlea). However, using accurate models of central/cognitive processes (beyond the cochlea) of human hearing in perceptual OQAM can enhance quality prediction [17]. In [17], some results of using the cognitive salience model in comparison to typical regression procedures such as ANN are also shown (see also [10]).

### SUMMARY

According to an embodiment, an apparatus for quality determination of an audio signal may have: a perceptual model for receiving the audio signal and for determining distortion information for each of one or more distortion metrics, wherein each distortion metric of the one or more distortion metrics depends on a comparison between a feature of the audio signal and of a corresponding feature of reference information, and a distortion-to-quality mapping module for determining a quality of the audio signal depending on the distortion information for each of the one or more distortion metrics and depending on information on one or more cognitive effects.

According to another embodiment, a method for quality determination of an audio signal may have the steps of: receiving the audio signal and determining distortion information for each of one or more distortion metrics, wherein each distortion metric of the one or more distortion metrics depends on a comparison between a feature of the audio signal and of a corresponding feature of reference information, and determining a quality of the audio signal depending on the distortion information for each of the one or more distortion metrics and depending on information on one or more cognitive effects.

Another embodiment may have a non-transitory digital storage medium having a computer program stored thereon to perform the method for quality determination of an audio signal, when said computer program is run by a computer.

An apparatus for quality determination of an audio signal according to an embodiment is provided. The apparatus comprises a perceptual model for receiving the audio signal and for determining distortion information for each of one or more distortion metrics, wherein each distortion metric of the one or more distortion metrics depends on a comparison between a feature of the audio signal and of a corresponding feature of reference information. Moreover, the apparatus comprises a distortion-to-quality mapping module for determining a quality of the audio signal depending on the distortion information for each of the one or more distortion metrics and depending on information on one or more cognitive effects.

Moreover, an audio encoder for encoding an audio signal according to an embodiment is provided. The audio encoder comprises an apparatus as described above for determining a quality of a decoded signal. The apparatus is configured to receive an original signal as the reference signal. The decoded signal results from a decoding of an encoded audio signal, wherein the encoded audio signal encodes the original audio signal. The audio encoder is configured to determine one or more coding parameters depending on a quality of the decoded audio signal.

Furthermore, a method for quality determination of an audio signal according to an embodiment is provided. The method comprises:
Receiving the audio signal and determining distortion information for each of one or more distortion metrics, wherein each distortion metric of the one or more distortion metrics depends on a comparison between a feature of the audio signal and of a corresponding feature of reference information. And:
Determining a quality of the audio signal depending on the distortion information for each of the one or more distortion metrics and depending on information on one or more cognitive effects.

Moreover, a method for audio encoding according to an embodiment is provided. The method comprises the method as described above for determining a quality of a decoded signal. The reference information comprises information on a reference signal, wherein each distortion metric of the plurality of distortion metrics depends on a comparison between a feature of the audio signal and of a corresponding feature of the reference signal. The reference signal is an original audio signal, and wherein the audio signal is a decoded signal resulting from a decoding of an encoded audio signal, wherein the encoded audio signal encodes the original audio signal. Furthermore, the method comprises receiving an original signal as the reference signal, wherein the decoded signal results from a decoding of an encoded audio signal, wherein the encoded audio signal encodes the original audio signal.

Moreover, the method comprises determining one or more coding parameters depending on a quality of the decoded audio signal.

Furthermore, computer programs are provided, wherein each of the computer programs is configured to implement one of the above-described methods when being executed on a computer or signal processor.

### BRIEF DESCRIPTION OF THE DRAWINGS

Embodiments of the present invention will be detailed subsequently referring to the appended drawings, in which:

FIG. 1 illustrates an apparatus for quality determination of an audio signal according to an embodiment.

FIG. 2 illustrates a scheme of a multidimensional objective quality assessment method.

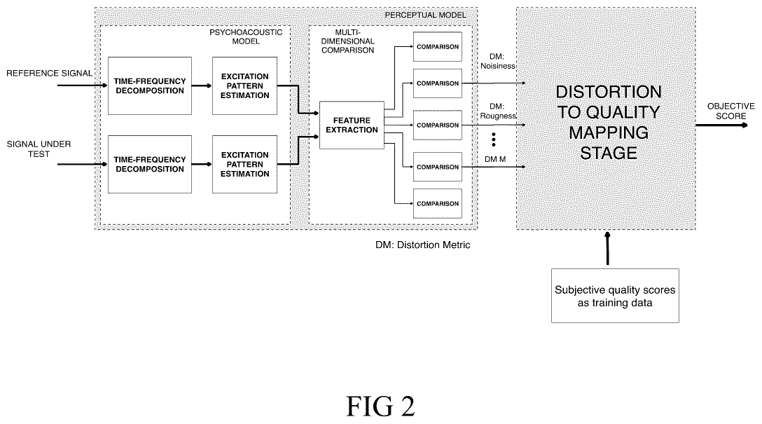

FIG. 3 illustrates a multidimensional objective quality assessment method according to an embodiment, which takes cognitive effects into account.

FIG. 4 illustrates a block diagram of a perceptual quality measurement system according to an embodiment.

FIG. 5 illustrates a basis functions mapping of individual distortion metrics to the MUSHRA quality scale.

FIG. 6 illustrates a first objective quality assessment method according to an embodiment.

FIG. 7 illustrates an audio encoder according to an embodiment.

FIG. 8 illustrates an overall PQMS Performance.

FIG. 9 illustrates pooled coding condition subjective quality scores and objective quality predictions.

FIG. 10 illustrates time/frequency plots of the EHS DM and investigated CEMs for a violin recording coded with bandwidth extension techniques

FIG. 11 illustrates a comparison of the proposed full system performances on the database USAC VT 1 of FIG. 6 and a reduced (FFT mostly features) version.

### DETAILED DESCRIPTION OF THE INVENTION

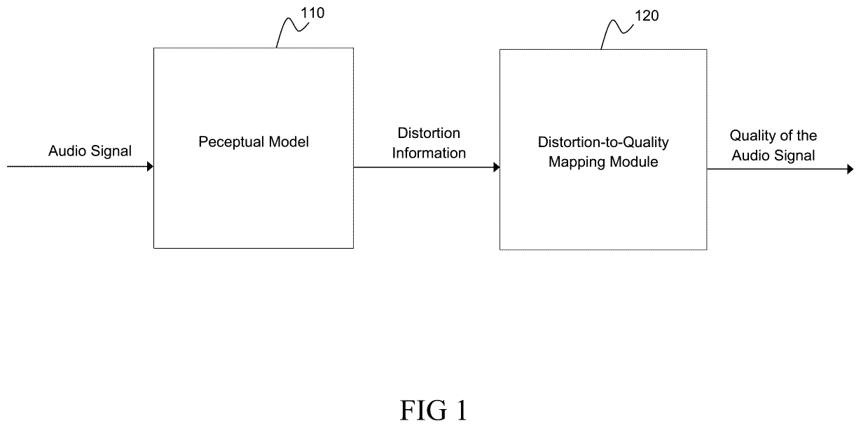

FIG. 1 illustrates an apparatus for quality determination of an audio signal according to an embodiment.

The apparatus comprises a perceptual model 110 for receiving the audio signal and for determining distortion information for each of one or more distortion metrics, wherein each distortion metric of the one or more distortion metrics depends on a comparison between a feature of the audio signal and of a corresponding feature of reference information.

Moreover, the apparatus comprises a distortion-to-quality mapping module 120 for determining a quality of the audio signal depending on the distortion information for each of the one or more distortion metrics and depending on information on one or more cognitive effects.

According to an embodiment, the one or more cognitive effects may, e.g., comprise at least one of informational masking information and perceptual streaming information. The distortion-to-quality mapping module 120 may, e.g., be configured to determine the quality of the audio signal depending on the distortion information for each of the one or more distortion metrics and depending on at least one of the informational masking information and the perceptual streaming information.

In an embodiment, the one or more cognitive effects may, e.g., be two or more cognitive effects which comprise the informational masking information and the perceptual streaming information. The distortion-to-quality mapping module 120 may, e.g., configured to determine the quality of the audio signal depending on the distortion information for each of the one or more distortion metrics, depending on the informational masking information and depending on the perceptual streaming information.

In an embodiment, the one or more cognitive effects may, e.g., comprise other cognitive effects. For example, another such cognitive effect may, e.g., be comodulation masking release (CMR, an effect investigated in [10]).

According to an embodiment, the perceptual model 110 may, e.g., be configured to determine the informational masking information depending on signal variations of the audio signal in a vicinity of a masking threshold.

For example, the perceptual model 110 may, e.g., determine “distortion information”, and “cognitive information” (e.g., an amount of IM or PS). The perceptual model 110 may, e.g., inform the distortion-to-quality mapping module, and the distortion-to-quality mapping module 120 may, e.g., determine quality based on the distortion information and the cognitive information of the perceptual model. The distortion-to-quality mapping module 120 may, e.g., determine, for example, the “salience” (for example, weights) of the distortion information, using both the distortion information and the cognitive information. So, in an embodiment, the perceptual model 110 may, e.g., the one in charge of determining the information and the distortion-to-quality mapping module 120 may, e.g., the one in charge of determining quality based on the information of the perceptual model.

In an embodiment, the perceptual model 110 may, e.g., be configured to determine the informational masking information and the perceptual streaming information depending on an excitation pattern (E_{T}) of the audio signal and on an excitation pattern (E_{R}) of the perceptual streaming information.

According to an embodiment, the perceptual model 110 may, e.g., be configured to determine the informational masking information, such that the informational masking depends on a difference (E_{T}−E_{R}) between an excitation pattern (E_{T}) of the audio signal and an excitation pattern (E_{R}) of the reference information.

In an embodiment, the perceptual model 110 may, e.g., be configured to determine the informational masking information, such that, for each time index (n) of a plurality of time indices, for each frequency index (k) of a plurality of frequency indices (K), the informational masking information depends on a difference (E_{T}−E_{R}) between an excitation pattern (E_{T}) of the audio signal for a time-frequency bin ((n,k)) of said time index (n) and of said frequency index (k) and an excitation pattern (E_{R}) of the reference information for said time-frequency bin ((n,k)).

According to an embodiment, the perceptual model 110 may, e.g., be configured to determine the informational masking information by determining a variance (var(β) of a term (β) over a time window, wherein the term depends on a difference (E_{T}−E_{R}) between an excitation pattern (E_{T}) of the audio signal and an excitation pattern (E_{R}) of the reference information.

In an embodiment, the perceptual model 110 may, e.g., be configured to determine the informational masking information by determining, for each frequency index (k) of a plurality of frequency indices (K), a variance (var(β) of a term (β) over a time window, wherein, for each time index (n) of all time indices of the time window, the term depends on a difference (E_{T}−E_{R}) between an excitation pattern (E_{T}) of the audio signal of a time-frequency bin ((n,k)) of said time index (n) and of said frequency index (k) and an excitation pattern (E_{R}) of the reference information for said time-frequency bin ((n,k)).

According to an embodiment, the perceptual model 110 may, e.g., be configured to determine the informational masking information by summing the variance of the term of each frequency index (k) of the plurality of frequency indices (K).

In an embodiment, the time window exhibits a time duration, which may, e.g., be greater than or equal to 5 ms, and which may, e.g., be smaller than or equal to 800 ms.

According to an embodiment, the perceptual model 110 may, e.g., be configured to determine the informational masking information, such that the informational masking information may, e.g., be defined depending on

$$\frac{1}{K} {\sum }_{1}^{K} var ( β ( n , k ) )$$

wherein β(n, k) indicates the term for a time-frequency bin (n, k) with time index n and frequency index k, wherein var(β(n, k)) indicates the variance of the term β(n, k) over the time window, and wherein K indicates a number of the plurality of frequency bins.

In an embodiment, the term (β) may, e.g., be defined depending on

$$β = {e}^{- α ( {E}_{T} - {E}_{R} ) / {E}_{ref}}$$

wherein E_{T} indicates the excitation pattern (E_{T}) of the audio signal for a time-frequency bin, wherein E_{R} indicates the excitation pattern (E_{T}) of the reference signal for said time-frequency bin, wherein E_{R} indicates an excitation pattern (E_{T}) for a reference pattern for said time-frequency bin, and wherein α may, e.g., be a positive real value, e.g., indicating an amount of partial masking.

According to an embodiment, the one or more distortion metrics are a plurality of distortion metrics. The perceptual model 110 may, e.g., be configured to determine the distortion information for each of the plurality of distortion metrics, wherein each distortion metric of the plurality of distortion metrics depends on a comparison between a feature of the audio signal and of a corresponding feature of the reference information. The distortion-to-quality mapping module 120 may, e.g., be configured to determine the quality of the audio signal depending on the distortion information for each of the plurality of distortion metrics, depending on the informational masking information and depending on the perceptual streaming information.

In an embodiment, the perceptual model 110 may, e.g., be configured to determine a distortion value as the distortion information for each of the plurality of distortion metrics. The perceptual model 110 may, e.g., be configured to determine an informational masking value as the informational masking information. Moreover, the perceptual model 110 may, e.g., be configured to determine a perceptual streaming value as the perceptual streaming information. The distortion-to-quality mapping module 120 may, e.g., be configured to determine the quality of the audio signal depending on the distortion value for each of the plurality of distortion metrics, depending on the informational masking value and depending on the perceptual streaming value.

According to an embodiment, the distortion-to-quality mapping module 120 may, e.g., be configured to determine the quality of the audio signal by determining a plurality of quality score values by determining, for each distortion metric of the plurality of distortion metrics, a quality score value of the plurality of quality score values, e.g., a MUSHRA score value, from the distortion value for said distortion metric using a distortion-to-quality mapping function of a plurality of distortion-to-quality mapping functions.

In an embodiment, the distortion-to-quality mapping module 120 may, e.g., be configured to determine the quality of the audio signal by applying the informational masking value or by applying a value derived from the informational masking value on the quality score value or on a value derived from the quality score value of one or more of the plurality of distortion metrics. Moreover, the distortion-to-quality mapping module 120 may, e.g., be configured to determine the quality of the audio signal by applying the perceptual streaming value or by applying a value derived from the perceptual streaming value on the quality score value or on a value derived from the quality score value of at least one of the plurality of distortion metrics.

According to an embodiment, the distortion-to-quality mapping module 120 may, e.g., be configured to determine the quality of the audio signal such that the quality of the audio signal depends on a linear combination of the distortion value for each of the plurality of distortion metrics, the informational masking value and the perceptual streaming value.

Or, the distortion-to-quality mapping module 120 may, e.g., be configured to determine the quality of the audio signal such that the quality of the audio signal depends on a linear combination of the informational masking value and of the perceptual streaming value and of the plurality of quality score values that have been determined by the distortion-to-quality mapping module 120 using the plurality of distortion-to-quality mapping functions.

In an embodiment, the plurality of distortion metrics comprise at least two distortion metrics of:
a distortion metric indicating a band limitation of the audio signal (AvgLinDist),
a distortion metric indicating a temporal modulation of disturbances of the audio signal (RmsModDiff),
a distortion metric indicating an added noise in the audio signal (RmsNoiseLoud),
a distortion metric indicating missing spectro-temporal components in the audio signal (RmsMissingComponents),
a distortion metric indicating a harmonic structure of error of the audio signal (EHS),
a distortion metric indicating a noisiness and/or audibility of coding noise in the audio signal (Segmental NMR),

The distortion-to-quality mapping module 120 may, e.g., be configured to determine the quality of the audio signal depending on said at least two distortion metrics.

According to an embodiment, said at least two distortion metrics comprise the distortion metric indicating the harmonic structure of error of the audio signal (EHS) and the distortion metric indicating the noisiness and/or the audibility of coding noise in the audio signal (Segmental NMR). The distortion-to-quality mapping module 120 may, e.g., be configured to determine the quality of the audio signal depending on the distortion metric indicating the harmonic structure of error of the audio signal (EHS) and depending on the distortion metric indicating the noisiness and/or the audibility of coding noise in the audio signal (Segmental NMR).

In an embodiment, said at least two distortion metrics further comprise the distortion metric indicating the band limitation of the audio signal (AvgLinDist). The distortion-to-quality mapping module 120 may, e.g., be configured to determine the quality of the audio signal further depending on the distortion metric indicating the band limitation of the audio signal (AvgLinDist).

According to an embodiment, the reference information may, e.g., comprise information on a reference signal. Each distortion metric of the plurality of distortion metrics depends on a comparison between a feature of the audio signal and of a corresponding feature of the reference signal.

In an embodiment, the reference signal may, e.g., be an original audio signal. The audio signal may, e.g., be a decoded signal resulting from a decoding of an encoded audio signal, wherein the encoded audio signal encodes the original audio signal.

According to an embodiment, the perceptual model 110 may, e.g., comprise a psychoacoustic model and a multi-dimensional comparison unit. The psychoacoustic model may, e.g., be configured to receive the audio signal, to conduct a time-frequency decomposition of the audio signal to obtain a plurality of time-frequency components of the audio signal, and to determine a plurality of excitation patterns of the audio signal from the plurality of time-frequency components of the audio signal. Moreover, the psychoacoustic model may, e.g., be configured to receive the reference signal, to conduct a time-frequency decomposition of the reference signal to obtain a plurality of time-frequency components of the reference signal, and to determine a plurality of excitation patterns of the reference signal from the plurality of time-frequency components of the reference signal. The multi-dimensional comparison unit may, e.g., be configured to extract a plurality of features of the audio signal from the plurality of excitation patterns of the audio signal. Furthermore, the multi-dimensional comparison unit may, e.g., be configured to extract a plurality of features of the reference signal from the plurality of excitation patterns of the reference signal. The one or more distortion metrics are a plurality of distortion metrics. For determining the distortion information for each distortion metric of the plurality of distortion metrics, the multi-dimensional comparison unit may, e.g., be configured to conduct one or more comparisons depending on one or more of the plurality of features of the audio signal and depending on one or more of the plurality of features of the reference signal and depending on said distortion metric. The distortion-to-quality mapping module 120 may, e.g., be configured to determine the quality of the audio signal depending on the distortion information for each of the plurality of distortion metrics, depending on the informational masking information and depending on the perceptual streaming information.

In an embodiment, the reference information may, e.g., comprise a plurality of parameters which may, e.g., depend on a listener preference.

According to an embodiment, the informational masking information may, e.g., indicate a degree of decrease in the audibility of distortions of the audio signal caused by rapid fluctuations of the audio signal in time.

In an embodiment, the perceptual streaming information may, e.g., indicate a degree of signal disturbances of the audio signal that form a separate percept from the audio signal compared to distortions that form a single percept with the audio signal.

According to an embodiment, the distortion-to-quality mapping module 120 may, e.g., be implemented as a cognitive salience model.

In an embodiment, the distortion-to-quality mapping module 120 may, e.g., be implemented as a multivariate-regression.

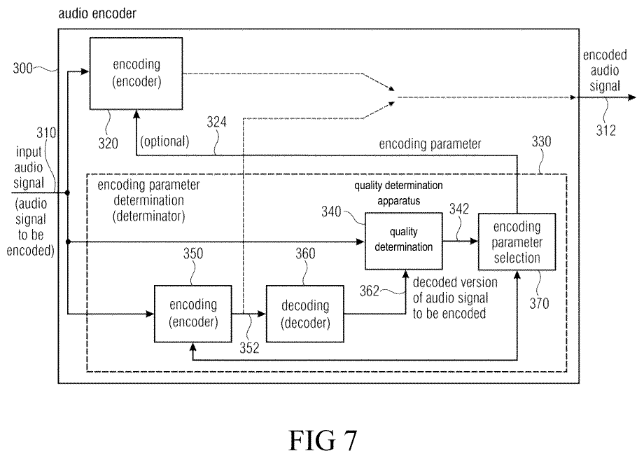

Moreover, an audio encoder for encoding an audio signal according to an embodiment is provided (see, for example, FIG. 7 as a particular embodiment for such an audio encoder. However, it should be noted that FIG. 7 comprises a plurality of optional features that are not necessary for implementing an audio encoder according to the invention).

The audio encoder 300 comprises an apparatus 340 being an apparatus according to FIG. 1 for determining a quality of a decoded signal. The apparatus 340 is configured to receive an original signal as the reference signal. The decoded signal results from a decoding of an encoded audio signal, wherein the encoded audio signal encodes the original audio signal.

The audio encoder 300 is configured to determine one or more coding parameters depending on a quality of the decoded audio signal.

According to an embodiment, the audio encoder 300 may, e.g., be configured to encode, depending on the quality of the decoded audio signal, one or more bandwidth extension parameters (324) which define a processing rule to be used at a side of an audio decoder to derive a missing audio content on the basis of an audio content of a different frequency range encoded by the audio encoder. And/or, the audio encoder 300 may, e.g., be configured to encode, depending on the quality of the decoded audio signal, one or more audio decoder configuration parameters which define a processing rule to be used at the side of an audio decoder.

In an embodiment, the audio encoder 300 may, e.g., be configured to support an Intelligent Gap Filling. Furthermore, the audio encoder 300 may, e.g., be configured to determine one or more parameters 324 (see FIG. 7) of the Intelligent Gap Filling using a determination of the quality of the decoded audio signal.

According to an embodiment, the audio encoder 300 may, e.g., be configured to select one or more associations between a source frequency range (sT[·]) and a target frequency range (tile[·]) for a bandwidth extension and/or one or more processing operation parameters for a bandwidth extension depending on the quality of the decoded audio signal.

In an embodiment, the audio encoder 300 may, e.g., be configured to select one or more associations between a source frequency range and a target frequency range for a bandwidth extension. Moreover, the audio encoder 300 may, e.g., be configured to selectively allow or prohibit a change of an association between a source frequency range and a target frequency range depending on an evaluation of a modulation of an envelope in an old or a new target frequency range.

In the following, further embodiments of the present invention are described.

The invention proposes an improvement of the current efforts to tackle the prediction of the quality of coded audio signals as perceived by human subjects, using computer algorithms. These algorithms analyze the coded signal and extract features (i.e., quality metrics) that are expected to correlate with perceived quality subject response scores in listening tests. The algorithm may also make use of an uncoded/unprocessed, reference signal as point of reference for the comparison. The algorithmic estimation of perceived quality is usually termed “objective quality assessment method (OQAM)” (as opposed to “subjective” quality assessment methods using human listeners) or just “quality measurement”.

Embodiments are also based on the improvement of a perceptual OQAM by adding models of central/cognitive auditory phenomena to their existing perceptual models.

Embodiments are based on the finding that central/cognitive phenomena can regulate the salience of the perceived distortions. In the context of a multidimensional OQAM, these cognitive effects can therefore modify their weights in the distortion-to-quality mapping stage presented in [17].

A salience weighting based on cognitive effects can counteract the mentioned overestimation incurred by some quality metrics in the case of parametrically coded audio signals. Especially for music signals and other signals with harmonic content.

Embodiments take cognitive effects into account.

Particularly, a series quality metrics from an established OQAM, PEAQ, is taken into account: PEAQ [15] can be complemented with new models of two known cognitive phenomena known to affect audio quality perception, for increased performance, see [19].

According to embodiments, informational masking (IM) is taken into account. Informational masking is a cognitive phenomenon that describes a decrease in the audibility of certain distortions when the signals strongly fluctuate rapidly in time (see [19]). Therefore, informational masking can potentially decrease the perceived severity of the distortions.

In embodiments, perceptual streaming (PS) is taken into account. Perceptual streaming are signal disturbances that form a separate percept from the audio signal will generally be judged more critically than distortions that form a single percept with the audio signal. An example of a distortion that forms a separate percept from the audio signal is for example, the presence of the so-called “spectral holes” in audio coding, resulting from spectral-temporal components left out by the codecs [20]. The effect of perceptual streaming can increase the perceived severity of a distortion.

According to some embodiments, both perceptual streaming and informational masking are taken into account.

The effects of perceptual streaming and informational masking can be seen as complementary because informational masking decreases the perceived severity of the disturbances and perceptual streaming increases it.

The proposed solution implements models of informational masking and perceptual streaming, whose outputs are described as Cognitive Effect Metrics or Measures (CEM).

According to embodiments, concepts, e.g., a method for incorporating cognitive effects, and a distortion-to-quality mapping module, e.g., a cognitive salience model, is provided.

The central assumption is that central/cognitive phenomena (measured by the CEM) can regulate the salience of the perceived distortions (measured by the DM).

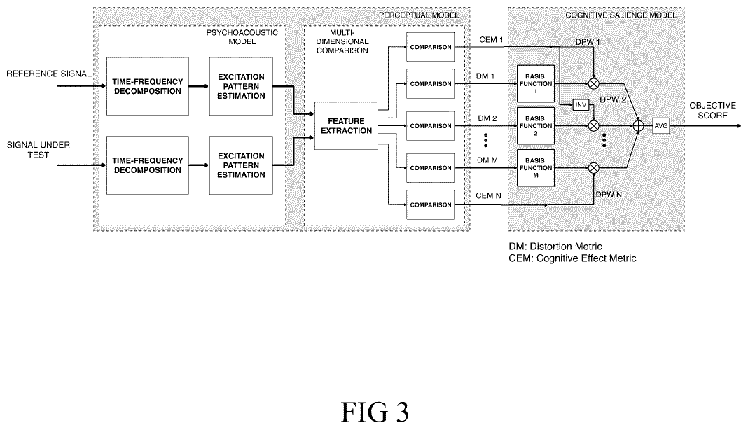

FIG. 3 illustrates an objective quality assessment method according to an embodiment, which takes cognitive effects into account.

In the context of a multidimensional objective quality assessment method (OQAM), according to embodiments, these cognitive effects may, e.g., modify their weights in the distortion-to-quality mapping stage. According to an embodiment, the distortion-to-quality mapping stage [17] is replaced by a cognitive salience model (CSM) ([17]).

Each CEM corresponding to informational masking and perceptual streaming weights some of the distortion metrics of PEAQ described in Table 1. Below is a diagram of the proposed OQAM with such a weighting scheme [17]:

The perceptual model block is mostly based on PEAQ, on its advanced version. The calculation of the DMs corresponds to the MOVs listed in Table 1, except that they are not necessarily averaged in time and frequency over the whole duration of the test signals.

The CEMs may, e.g., be calculated as described below.

TABLE 2

| CEM | Description |
|---|---|
| PS | Perceptual |
| | Streaming Cognitive |
| | Metric |
| IM | Informational |
| | Masking Cognitive |
| | Metric (in Paper |
| | ICASSP 2023) on its |
| | “beta” var version, which |
| | is the proposed IM |
| | metric. |
| PS/IM | Combined |
| | complementary metric. |

Table 2 describes involved cognitive effect metrics according to an embodiment.

The “Cognitive Salience Model” represents a distortion-to-quality mapping stage that is an alternative to typical regression models used in other OQAMs (see [17]).

In order to analyze which CEM interact with which distortion metrics (DMs), a data-driven analysis of interactions explained in [17] and below is carried out. An example is provided below.

The basis functions correspond to a simple one-to-one mapping between the distortion metric (DM) and a subjective quality scale. The basis functions transform the DM values into a quality score value. For the mapping, a special listening test database of isolated audio coding artifacts was used. The procedure is explained with more details in [17]. The basis functions used in this system map the PEAQ DM to MUSHRA [21] scores.

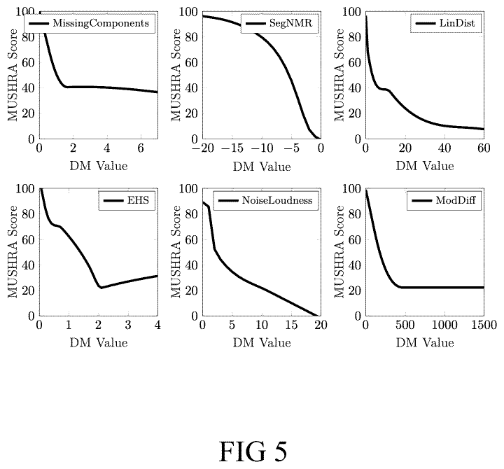

FIG. 5 illustrates a basis functions mapping of individual distortion metrics to the MUSHRA quality scale. 100 points means excellent quality, decreasing MUSHRA score points mean decreasing perceived quality.

The INV operation in the diagram translates to INV(x)=1−x, provided that the multiplying factors CEM 1 . . . . N are normalized between 0 and 1. It accounts for two possible cases:

The case in which some cognitive effects can hinder the salience of a distortion type (e.g., a larger effect of informational masking decreases the perceived severity of a distortion), and therefore, the CEM can lower the importance weighting in the final objective measure.

The case in which a cognitive effect increases the perceived severity, but the DM has an inverse polarity. For example, the SegmentaINMR (a noise-to-mask ratio) DM of Table 1 has large negative values for signals of good quality (e.g. SegNMR=−15) and negative values near 0 for signals of bad quality (high noisiness above the masking threshold, e.g., SegNMR=−5).

The AVG operation implements time averaging of the objective score, to a desired temporal resolution. It can also be the whole duration of the signal.

Results from [17] and from the concepts described below that lead to an improved OQAM

According to an embodiment, once the DM and different CEM are available, the Cognitive Salience Model parameters were selected based on a data-driven interaction analysis.

A data-driven analysis of interactions (for mode detail on the method see [17]). established that the CEMs of Table 2 interacted meaningfully with the following DMs of Table 1; for the results see Table 3 below.

The provided IM metric interacts inversely (Table 3 below; Coeff −0.85) with EHS (harmonic structure of error), meaning: the larger Informational Masking effect, the less important errors with harmonic structures are for the quality measurement (they have a less salient role in perceived quality).

The analyzed PS metric interacts directly with EHS (Table 3 below. Coeff +0.73), meaning: the larger the perceptual streaming effect, the more important errors with harmonic structures are.

The proposed IM metric interacts inversely with SegmentaINMR (Table 3 below. Coeff −0.73), meaning: larger informational masking hinders the audibility of coding noise.

There are no other meaningful interactions of CEMS and DMs: the rest of the DMs of table 1 enter the dm-to-quality mapping stage unmodified.

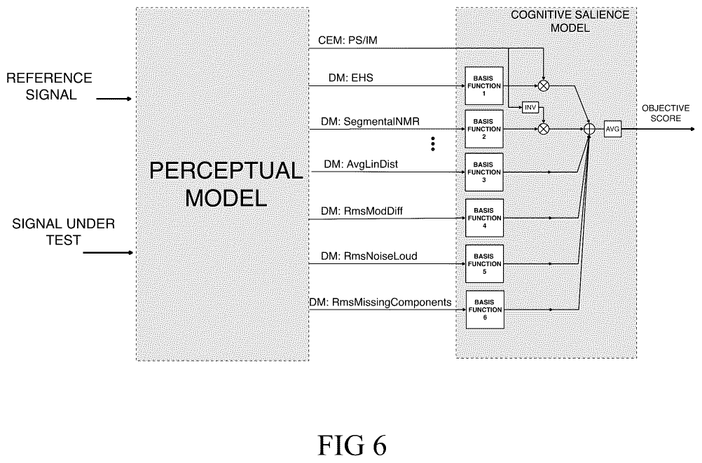

Based on these results, according to an embodiment, the model of FIG. 6 is provided.

In particular, FIG. 6 illustrates a first objective quality assessment method according to an embodiment.

The INV operation represents (1−x): which means that the SegmentalNMR is weighted as (1−IM/PS)*SegmentaINMR: Although the analysis of interactions showed the same behavior of IM/PS as with EHS, the inversion operation comes from the inverse polarity of SegmentaINMR, as explained before.

The DMs and CEMS are averaged over frequency as described in PEAQ

Some embodiments are based on the finding the concepts of [17] may, e.g., be employed in further developed versions, see below. For example, the exact details and the exact calculations of the quality metric provide new and inventive concepts.

According to embodiments, a calculation of an Informational Masking CEM (IM) as presented below is provided, which takes signal variations in the vicinity of the masking threshold into account and represents an improvement over the IM metric proposed in [19] [22].

In an embodiment, a combination of CEM and DM based on the proposed cognitive salience model in [17] is provided, in which a CEM can interact with two or more DMs describing multiple aspects of quality degradation (not just one such as coding noise), hindering or facilitating the use of a particular DM, based on an analysis of interactions proposed in [17].

According to embodiments, a particular combination of perceptual streaming/informational masking and SegmentaINMR (segmental noise-to-mask ratio) and

EHS (harmonic structure of error) for an objective quality assessment method is provided:

The EHS of Table 1 describes the “harmonic structure” or “tonality” of errors; a property closely related to the error structure of music signals codec with band replication parameters.

According to an embodiment, the informational masking metric described below determines masking based on temporal fluctuations/modulations of the signal (in the vicinity of the masking threshold) and hinders overestimation of the EHS measure when the fluctuations of the signals are significant.

The interaction between the two metrics is then in line with the modulation properties and harmonic structures of errors described in [20].

According to an embodiment, a particular combination of perceptual streaming/informational masking and AvgLinDist (average of the linear distortions), EHS (harmonic structure of err), Segmental, described as a simplified model, is provided.

Embodiments may, e.g., be employed for automatic quality measurement of coded audio signals, particularly, in automatic quality control of audio codec development for daily use. Further embodiments may, e.g., also be employed for the applications listed in [15].

Moreover, embodiments may, e.g., be employed for automatic quality measurement of generally processed audio signals, not necessarily audio codecs. E.g., embodiments may, e.g., be employed for an automated quality measurement (objective) method that can predict the subjective listening test results, for example, of the subjective method described in [21].

Furthermore, embodiments, may, e.g., be employed for the applications listed in [10], e.g., for quality measurement/quality determination as explained before.

In the following, considerations on the feasibility of embodiments and complexity reduction aspects are discussed.

For a block-based approach in parameter control of the encoder, two properties are desired, namely, low latency and low complexity.

Generally, an OQAM with acceptable performance may, e.g., need the use of filter banks approaching the auditory spectro-temporal resolution of the human hear, which are of high complexity.

Additionally, the quality metrics may, e.g., usually need a temporal analysis window of some seconds to render meaningful descriptors of quality (high latency).

A solution for block-wise calculation proposed in is to use a neural network/deep learning approach trained with the OQAM. This is also possible with the presented OQAM according to some embodiments.

Regarding the low complexity and latency problem, it may be possible to implement a system that mostly uses FFT-based features. The use of an FFT-only OQAM represents a step forward towards the needed block-wise analysis, due to lower complexity and possibly lower latency that a filter bank-based approach.

The system of FIG. 6 may, e.g., be reduced to use only AvgLinDist, EHS and SegmentalNMR, with the proposed IM and PS CEMs.

Of this system, AvgLinDist, IM and PS may, e.g., need the filter bank. However, FFT versions of these metrics are also possible to be implemented in the FFT domain with the help of the encoder's perceptual model. The performances of the full model and the mostly FFT based model are compared below.

As described below, an improved performance for the quality measurement of music signals coded with bandwidth extension is provided for the data analyzed.

In the following, further embodiments are described.

Firstly, an improved model of Informational Masking (IM), an important cognitive effect in quality perception, is provided that considers disturbance information complexity around the masking threshold. Secondly, the provided IM metric is incorporated into a PQMS using a novel interaction analysis procedure between cognitive effects and distortion metrics. The procedure establishes interactions between cognitive effects and distortion metrics using LT data.

The proposed IM metric is shown to outperform previously proposed IM metrics in a PQMS validation task against subjective quality scores from large and diverse LT databases.

Particularly, the proposed PQMS showed an increased quality prediction of music signals coded with bandwidth extension techniques, where other models frequently fail.

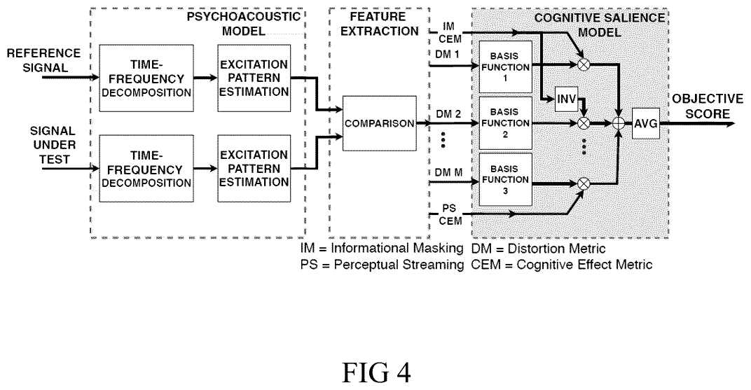

Embodiments are based on selected modifications of a MATLAB implementation of the Perceptual Evaluation of Audio Quality method (PEAQ) [15], a widely-adopted and validated PQMS. An unprocessed reference and a SUT are compared in the auditory internal representation (IR) domain. For the estimation of the IR, the time-frequency (T/F) decomposition, excitation pattern estimation and comparison stages correspond to that of PEAQ's advanced version. The used DMs are based on PEAQ's five Model Output Variables (MOVs) that describe different aspects of quality degradation, before time-frequency averaging. The Artificial Neural Network (ANN) of PEAQ that maps the MOVs to an overall quality score is replaced by the Cognitive Salience Model (CSM) proposed in [17], see FIG. 4.

FIG. 4 illustrates a block diagram of a Perceptual quality measurement systems (PEAQ-CSM) according to an embodiment.

In the CSM, cognitive effect metrics (CEM) such as models of IMPS, interact with basis functions (BF) mapping DMs to the quality domain by weighting their contribution to an overall quality score. Only DM-CEM interactions that strongly predict DM salience are included in the model. The CSM has been shown to outperform PEAQ's ANN mapping for the same number of input features. A time and frequency averaging over the whole duration of the analyzed signals (N time frames and K auditory bands) is applied as a Basic Audio Quality (BAQ) [21] objective predictor. The resulting PQMS is referred to as PEAQ-CSM.

In embodiments, the models of the three aspects of quality modelling involved: perceived disturbance loudness, IM (Informational Masking) and PS (Perceptual Streaming) are described below.

In the following, partial loudness of disturbances is described.

The perceived loudness of distortions has been shown to be an important predictor of audio quality degradation. The developers of PEAQ ([15]) proposed a distortion metric in which disturbance loudness is not only modeled well above the masking threshold, but also in the vicinity of the masking threshold (often called partial loudness). It is believed that the loudness behaviour of sound events in this region considerably differs from behaviors at well below or above the masking threshold [28]. These models specify that the loudness of sounds in this region is not zero, but take progressively smaller values as they approach the threshold of audibility. Some objective quality metrics map the perceived disturbance severity in this region to detection probabilities [15].

In PEAQ's partial disturbance loudness (PDL) metric, the instantaneous values of the excitation patterns for REF and SUT, E_{R} (n; k) and E_{T}(n; k) are compared at a time frame n and auditory band k (Indices (n; k) are omitted in Equation (1) for clarity):

$${N}^{′} = 0.068 {( \frac{1}{{s}_{T}} \frac{{E}_{th}}{{E}_{0}} )}^{γ} [ {( 1 + \frac{max ( {s}_{T} {E}_{T} - {s}_{R} {E}_{R} , 0 )}{{E}_{th} + {s}_{R} {E}_{R} \cdot β} )}^{γ} - 1 ] , \qquad ( 1 )$$

$$β = {e}^{- α ( {E}_{T} - {E}_{R} ) / {E}_{ref}} . \qquad ( 2 )$$

The coefficients Eₜₕ and E₀ are scaling constants and γ=0:23 (see [29]). The terms s_{R,T} incorporate the effect of signal modulations in the masking threshold level to account for asymmetry of masking effects between noise and tones [15].

The term β describes the disturbance behavior in the vicinity of the masking threshold and α=1:5 determines the amount of partial masking. An additional feature of PEAQ's metric is that the excitation patterns are processed by an adaptation procedure in which only non-linear additive distortions are considered. The roles of E_{R} (n; k) and E_{T}(n; k) in Equation (1) can be inverted to predict quality degradation due to missing components left by the audio codecs.

In order to analyze the previous approach in modelling IMPS of [19], a Barbedo and Lopes adaptation has been implemented into the PEAQ framework in the following manner:

$${𝒫𝒮}_{0} ( n , k ) = \frac{{E}_{T} ( n , k ) + 1}{{E}_{R} ( n , k ) + 1} , \qquad ( 3 )$$

$$𝒫𝒮 ( n , k ) = 0.5 \cdot {𝒫𝒮}_{0} ( n , k ) + 0.5 \cdot {𝒫𝒮}_{0} ( n - 1 , k ) . \qquad ( 4 )$$

The weighted average of previous frames in Equation (4) increases the value of the CEM when distortions are present over a consecutive amount of frames. The PS CEM can interact with the values of a distortion metric in that PS can regulate the perceived severity of the distortion. Increases in PS are expected to reinforce the predicted degradation as measured by a distortion metric.

Similarly, IM is implemented as:

$$𝒫𝒮ℰ𝒱 ( n , k ) = \vert {E}_{R} ( n , k ) - \overline{p} ( n , k ) \vert \qquad ( 5 )$$

$$ℐℳ ( n ) = 𝒫𝒟ℰ𝒱 ( n ) = \frac{1}{K} {\sum }_{1}^{K} 𝒫𝒟ℰ𝒱 ( n , k ) \qquad ( 6 )$$

where p̅ is the mean signal power calculated over a 20 ms time window. The CEM PDEV(n) predicts the amount of IM at a given time n. Disturbances above the masking threshold as calculated in the PDL DM of Equation (1) can be masked when the power variation increases, as the signal becomes more complex. In this case, the PDL DM may overestimate quality degradation by not considering audibility threshold increases due to increased signal complexity. Therefore, the IM CEM can interact with the PDL DM to counteract the overestimation.

Considering the complementary effect between PS and IM, a disturbance loudness distortion metric such as the one of Equation (1) has been extended in as follows:

$${N}_{IMPS}^{′} ( n , k ) = ℐℳ𝒫𝒮 ( n , k ) \cdot {N}^{′} ( n , k ) . \qquad ( 7 )$$

$${N}_{IMPS}^{′} ( n , k ) = \frac{C \cdot {𝒫𝒮 ( n , k )}^{a} \cdot {N}^{′} ( n , k )}{{𝒫𝒟ℰ𝒱 ( n )}^{b} + C} \qquad ( 8 )$$

the constants a; b and C are chosen to directly interact with the values of a noise loudness metric, whereas Lopes and Barbedo considered the term [symbol] [symbol] [symbol] [symbol] as a separate DM in a DM-to-quality mapping stage.

The previous approach in modeling IM using signal power variations considers the properties of the input signal independently of the operational region of masker signal and disturbances mentioned above. Additionally, previous approaches either specify the IMPS model interaction with one particular DM (see [25], e.g., Equation (7)) or rely on a general-purpose regression procedure to find interactions of CEMs with other DMs (see [22]). Embodiments are related to these two aspects.

Embodiments provide an IM model based on disturbance behavior in the partial loudness region using the following arguments: As the disturbance severity in this region can be mapped to a detection probability, the signals' stochastic properties (e.g., power deviations) will have a considerable influence in modelling quality degradation.

Additionally, the majority of the IM models also consider masker variations as random variables modelling masking noise [30]. It is therefore assumed that a stochastic model of disturbance variation—particularly in the partial loudness region—will represent a more accurate picture of the intrinsic cognitive processes involved in IM than models considering overall signal power deviations in all loudness regions.

$$ℐℳ ( n ) = β - 𝒱𝒜ℛ ( n ) = \frac{1}{K} {\sum }_{1}^{K} var ( β ( n , k ) ) \qquad ( 9 )$$

where var(β) is the moving variance of the near-threshold masking term of Equation (1) with a time-window of 100 ms (Based on stimulus duration in [31]) and a normalization factor of N−1 time samples.

Secondly, we propose a more complex interaction model of the IM CEM with the available DMs in PEAQ than the previous approaches. In the previous approach, the nature of the interactions of the cognitive effect metrics with quality metrics was based on theoretical considerations (i.e., the influence of PS/IM in disturbance loudness correlate to perceived quality degradation) and validated by considering overall quality prediction performance on LT DBs. In some embodiments, a fix interaction with a DM as in Equation (7) is not assumed, but the CEM-DM salience interaction analysis that has been presented in [33] is performed. In the cited work, the interactions in the quality mapping model are chosen based on the Pearson correlation calculation of the CEM values against a data-driven salience metric defined on the DMs, over a representative LT DB. The CEM values that show a strong correlation with salience metric values calculated for a given DM are assumed to predict the salience of said DM's measured distortion (e.g., roughness or band limitation). The strong CEM-DM interactions stemming from the salience analysis are incorporated into PEAQ-CSM.

In the following, a validation experiment design is described.

The proposed PQMS with an IMPS model using the proposed IM metric (PEAQ-CSM β- [symbol] [symbol] [symbol] ) was validated using a series of LT DBs that contain carefully collected subjective data on a wide variety of audio-coding related signal degradations in different quality ranges. The DBs are the Unified Speech and Audio Coding Verification Tests 1 and 3 (USAC VT) [32] and the Enhanced Low Delay AAC Verification Test DBs (ELD VT). The test signals include music (isolated instruments and ensembles), speech (single and interfering speakers) with different levels of reverberation and other critical signals such as applause recordings. In total, 639 Mean Opinion Scores (MOS) pooled from thousands of individual listener responses (More than 25000 for USAC VT) in different labs were collected with the Multiple Stimuli with Hidden Reference and Anchor (MUSHRA) method [21]. Using these DBs, the performance of PEAQ-CSM β- [symbol] [symbol] [symbol] was compared to a first baseline PQMS PEAQ-CSM using the previous measure of IM (PEAQ-CSM [symbol] [symbol] ε [symbol] ) and to a second baseline PEAQCSM that does not incorporate any effects of IMPS.

Additionally, two established objective quality metrics, PEAQ DI (Advanced Version) and VISQOL Audio (NSIM) [11] were also included in the comparison. The overall performance was measured in terms of MOS/Objective score correlation R with a third-order polynomial function pre-mapping, as recommended in [33].

Results and explanations are now provided.

The CEM-DM salience interaction analysis results are shown in Table 3.

TABLE 3

| CEM | RmsNoiseLoud | SegmentalNMR | EHS |
|---|---|---|---|
| [symbol] [symbol] | 0.5 | 0.4 | 0.73 |
| [symbol] [symbol] ε [symbol] | −0.44 | −0.67 | −0.60 |
| β- [symbol] [symbol] [symbol] | −0.34 | −0.73 | −0.85 |

Table 3 describes CEM-DM Salience correlation values for the analysis DB USAC VT1. All other CEM-DM salience correlation values are less than 0.5 and Cl_{95%}<0:01.

It can be seen that the proposed β- [symbol] [symbol] [symbol] IM metric shows a moderate to strong prediction power over the perceptual salience of errors within harmonic structures, measured by the EHS MOV, and the salience of coding noise above the masking threshold, measured by the SegmentalNMR MOV [15]. The negative correlation values for IM indicate that increasing CEM values predict decreasing salience i.e., a larger IM effect size decreases the perceived severity of the associated distortion, as discussed above. Likewise, increasing CEM PS values predict the increased salience of the distortions measured by EHS. The selected interactions of the IMPS models with the mentioned MOVs are included into PEAQ-CSM. Remarkably, there is a weak interaction of the IMPS effect sizes with PEAQ's partial disturbance loudness metric, RmseNoiseLoud. For the data analyzed, an interaction as suggested by Equation (7) is not justified. This interaction is therefore not included in the PEAQ-CSM method.

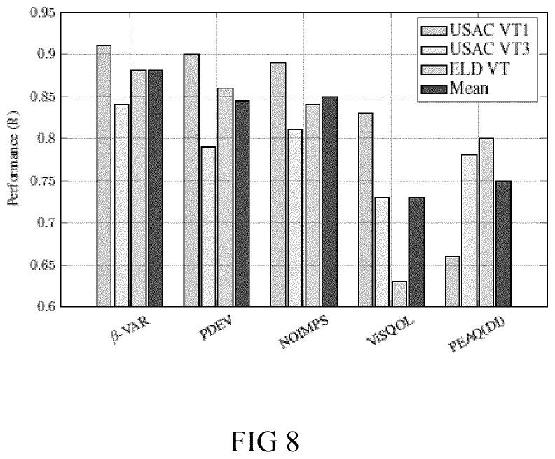

The overall performance results are shown in FIG. 8. In particular, FIG. 8 illustrates an overall PQMS Performance.

It can be seen that the quality metrics that incorporate interactions of IMPS models with the selected DM (methods PEAQ-CSM β- [symbol] [symbol] [symbol] and PEAQ-CSM [symbol] [symbol] ε [symbol] ) show a significant performance improvement compared to a baseline metric based on the same perceptual model (PEAQ-CSM) with no IMPS model (NOIMPS label), and to other established objective quality metrics. A significant improvement comes from modeling IM by using a complexity metric based on the disturbance variations in the partial loudness region (β- [symbol] [symbol] [symbol] ).

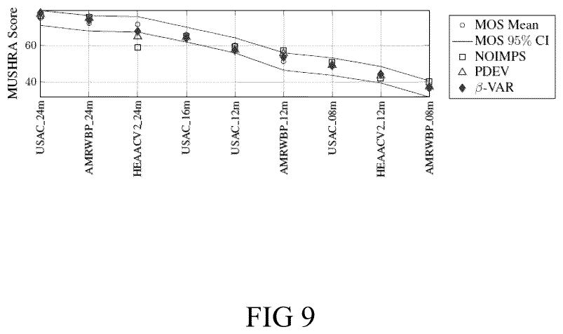

One of the strong points of the proposed IMPS model is illustrated in FIG. 9.

In particular, FIG. 9 illustrates pooled coding condition subjective quality scores and objective quality predictions (MUSIC ITEMS USAC VT 1).

The proposed IMPS model reduces the overestimation in quality degradation for the coding condition HEAACV 2 24m for music items. The HE-AAC v2 codec is known for its use of bandwidth extension techniques [34], which can generate coding artifacts with harmonic structures and disturbances related to small modulations of harmonic components in tonal signals [20] in the high frequency range.

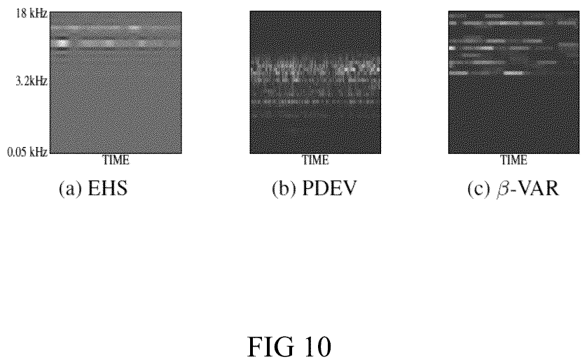

FIG. 10 illustrates T/F plots of the EHS DM and investigated CEMs for a violin recording coded with bandwidth extension techniques (see [35]).

These artifacts are picked up by the EHS DM as expected (see FIG. 10 (a)). However, at the used bitrate (24 kbps, mono), subjective scores indicate that the disturbances are not perceived as severely as predicted by said DM. The proposed IM metric β- [symbol] [symbol] [symbol] counteracts the overestimation of EHS in higher frequencies (FIG. 10 (c)) by considering the IM effect caused by small disturbance power variations around the masking threshold. In contrast, the PDEV metric based on total signal power variation fails to identify the region where IM interacts with the perceived distortion (FIG. 10 (b)). Limitations in the EHS DM for music signals were also reported in [18].

Moreover, as a performance metrics, a Pearson correlation against subjective scores has been conducted, with the evaluated DB:

TABLE 4

| Name | USAC VT 1 |
|---|---|
| Experiments | 1 |
| N References | 24 (8 speech, 8 music, 8 mixed) in mono format |
| N Conditions | 9 (8 to 24 kbps, USAC, AMR-WB+, HE-AACv2) |
| Max MOS | 83.33 |
| Min MOS | 21.74 |
| Mean MOS | 58.35 |
| N Data Points | 216 |

Table 4 describes an overview of the Listening Test Database 1 presented in ISO/IEC JTC1/SC29/WG11 (2011).

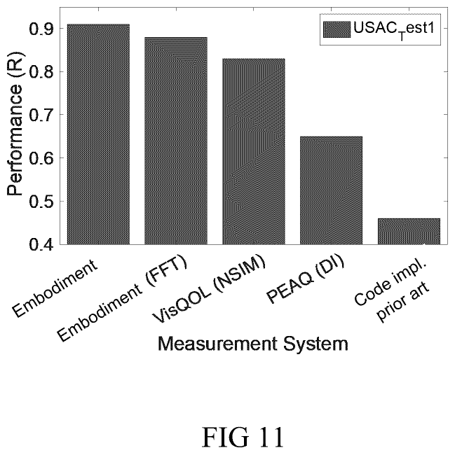

FIG. 11 illustrates a comparison of the proposed full system performances on the database USAC VT 1 of FIG. 6 and a reduced (FFT mostly features) version. Additionally, PEAQ DI measure and a code implementing conventional technology, e.g., the concept provided in [10], is shown.

Summarizing, the above consideration of models of central and cognitive audition in PQMSs improve quality prediction performance.

The proposed IM metric increased a PQMS performance in comparison to previous approaches. This is assumed to be due to the improved quality prediction of signals with coding errors caused by music signals that are coded with bandwidth extension techniques causing small impairments.

Some embodiments may take further phenomena such as co-modulation [27] and other perceptual organization models [36], and their interaction with different distortion metrics in PEAQ or other multidimensional PQMSs into account.

A quality measurement system according to an embodiment may, e.g., be employed for codec parameter selection.

FIG. 7 illustrates a respective audio encoder according to an embodiment.

The encoder 300 is configured to receive an input audio signal 310 (which is an audio signal to be encoded, or an “original audio signal”) and to provide, on the basis thereof, an encoded audio signal 312. The encoder 300 comprises an encoding (or encoder, or core encoder) 320, which is configured to provide the encoded audio signal 312 on the basis of the input audio signal 310. For example, the encoding 320 may perform a frequency domain encoding of the audio content, which may be based on the AAC encoding concept, or one of its extensions. However, the encoding 320 may, for example, perform the frequency domain encoding only for a part of the spectrum, and may apply a parametric bandwidth extension parameter determination and/or a parametric gap filling (as, for example, the “intelligent gap filling” IGF) parameter determination, to thereby provide the encoded audio signal (which may be a bitstream comprising an encoded representation of the spectral values, and an encoded representation of one or more encoding parameters or bandwidth extension parameters).

It should be noted, that the present description refers to encoding parameters. However, instead if encoding parameters, all the embodiments can generally use “coding parameters”, which may be encoding parameters (which are typically used both by the encoder and by the decoder, or only by the encoder) or decoding parameters (which are typically only used by the decoder, but which are typically signaled to the decoder by the encoder).

Typically, the encoding 320 can be adjusted to characteristics of the signal, and/or to a desired coding equality, using one or more encoding parameters 324. The encoding parameters may, for example, describe the encoding of the spectral values and/or may describe one or more features of the bandwidth extension (or gap filling), like an association between source tiles and target tiles, a whitening parameter, etc.

However, it should be noted that different encoding concepts can also be used, like a linear-predictive-coding based encoding.

Moreover, the audio encoder comprises an encoding parameter determination which is configured to determine the one or more encoding parameters in dependence on an evaluation of a similarity between an audio signal to be encoded and an encoded audio signal. In particular, the encoding parameter determination 330 is configured to evaluate the similarity between the audio signal to be encoded (i.e., the input audio signal 310) and the encoded audio signal using an apparatus for quality determination 340. For example, the audio signal to be encoded (i.e., the input audio signal 310) is used as a reference audio signal 192, 281 for the similarity evaluation by the apparatus for quality determination 340 and a decoded version 362 of an audio signal 352 encoded using one or more encoding parameters under consideration is used as the input signal (e.g., as the signal 110, 210) for the apparatus for quality determination 340. In other words, an encoded and subsequently decoded version 362 of the original audio signal 310 is used as in input signal 110, 210 for the quality measurement system, and the original audio signal 310 is used as a reference signal 192, 281 for the quality measurement system.

Thus, the encoding parameter determination 330 may, for example, comprise an encoding 350 and a decoding 360, as well as an encoding parameter selection 370. For example, the encoding parameter selection 370 may be coupled with the encoding 350 (and optionally also with the decoding 360) to thereby control the encoding parameters used by the encoding 350 (which typically correspond to decoding parameters used by the decoding 360). Accordingly, an encoded version 352 of the input audio signal 310 is obtained by the encoding 350, and an encoded and decoded version 362 is obtained by the decoding 360, wherein the encoded and decoded version 362 of the input audio signal 310 is used as an input signal for the similarity evaluation. A possible codec delay introduced in the signal path via 350 and 360 should be compensated for in the direct path of 310 before entering the similarity evaluation.

Accordingly, the encoding parameter selection 370 receives a similarity information 342 from the apparatus for quality determination 340. Typically, the encoding parameter selection 370 receives the similarity information 342 for different encoding parameters or sets of encoding parameters and then decides which encoding parameter or which set of encoding parameters should be used for the provision of the encoded audio signal 312, which is output by the audio encoder (for example, in the form of an audio bitstream to be sent to an audio decoder or to be stored).

For example, the encoding parameter selection 370 may compare the similarity information which is obtained for different encoding parameters (or for different sets of encoding parameters) and to select those encoding parameters for the provision of the encoded audio signal 312 which result in the best similarity information or, at least, in an acceptably good similarity information.

Moreover, it should be noted that the quality determination 340 may, for example, be implemented using the apparatus for quality determination according to FIG. 1 (or using any other apparatus for quality determination discussed herein). Moreover, it should be noted that the encoding 320 may optionally be omitted. For example, the encoded audio information 352, which is provided as an intermediate information when selecting the encoding parameter or encoding parameters, may be maintained (for example, saved as temporary information) and may be used in the provision of the encoded audio signal 312.

It should be noted that the audio encoder 300 according to FIG. 7 can be supplemented by any of the features, functionalities and details described herein, both individually and taken in combination. In particular, any of the details of the quality measurement system described herein can be introduced into the apparatus for quality determination 340.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] Herre, J. and Disch, S., Perceptual Audio Coding, pp. 757-799, Academic press, Elsevier Ltd., 2013.
[2] Schuller, G. and Härmä, A., “Low delay audio compression using predictive coding,” in 2002 IEEE International Conference on Acoustics, Speech, and Signal Processing, volume 2, pp. 1853-1856, 2002.
[3] Dietz, M., Liljeryd, L., Kjorling, K., and Kunz, O., “Spectral Band Replication, a Novel Approach in Audio Coding,” in Audio Engineering Society Convention 112, 2002.
[4] Herre, J. and Dietz, M., “MPEG-4 high-efficiency AAC coding [Standards in a Nutshell],” Signal Processing Magazine, IEEE, (Vol. 25, 2008), pp. 137-142, 2008.
[5] Disch, S., Niedermeier, A., Helmrich, C. R., Neukam, C., Schmidt, K., Geiger, R., Lecomte, J., Ghido, F., Nagel, F., and Edler, B., “Intelligent Gap Filling in Perceptual Transform Coding of Audio,” in Audio Engineering Society Convention 141, 2016.
[6] ISO/IEC (MPEG-H) 23008-3, “High efficiency coding and media delivery in heterogeneous environments-Part 3: 3D audio,” 2015.
[7] 3GPP, TS 26.445, EVS Codec Detailed Algorithmic Description; 3GPP Technical Specification (Release 12), 2014.
[8] Laitinen, M.-V., Disch, S., and Pulkki, V., “Sensitivity of Human Hearing to Changes in Phase Spectrum,” J. Audio Eng. Soc (Journal of the AES), (Vol. 61, No. 11, 2013), pp. 860-877, 2013.
[9] A. Rix und J. Beerends, “Objective assessment of speech and audio quality—technology and applications,” IEEE Transactions on Audio, Speech, and Language Processing, pp. 1890-1901, 6 2006.
[10] S. Disch, S. Van de Par et. al., “AUDIO SIMILARITY EVALUATOR, AUDIO ENCODER, METHODS AND COMPUTER PROGRAM”. US Patent Application US 2021/08247 A1, 18 03 2018.
[11] M. Chinen, F. S. C. Lim, J. Skoglund, N. Gureev, F. O'Gorman, and A. Hines, “ViSQOL v3: An open source production ready objective speech and audio metric,” in 2020 Twelfth International Conference on Quality of Multimedia Experience (QoMEX), 2020, pp. 1-6.
[12] R. Huber und B. Kollmeier, “PEMO-Q—A new method for objective audio quality assessment using a model of auditory perception.,” IEEE Transactions on audio, speech, and language processing, 2006.
[13] J. Beerends, “Perceptual objective listening quality assessment (polqa), the third generation itu-t standard for end-to-end speech quality measurement part i-temporal alignment.,” Journal of the Audio Engineering Society, 2013.
[14] A. Rix, “Perceptual Evaluation of Speech Quality (PESQ) The New ITU Standard for End-to-End Speech Quality Assessment Part I—Time-Delay Compensation,” Journal of the Audio Engineering Society, 2002.
[15] ITU-R Rec. BS.1387, Method for objective measurements of perceived audio quality, Geneva, Switzerland, 2001.
[16] J. Beerends, “A perceptual audio quality measure based on a psychoacoustic sound representation,” Journal of the Audio Engineering Society, 1992.
[17] Pablo M Delgado and Jürgen Herre, “A data-driven cognitive salience model for objective perceptual audio quality assessment,” in ICASSP 2022-2022 IEEE International Conference on Acoustics, Speech and Signal Processing (ICASSP). IEEE, 2022, pp. 986-990.
P. M. Delgado and J. Herre, “Can we still use PEAQ? a performance analysis of the ITU standard for the objective assessment of perceived audio quality,” in 2020 Twelfth International Conference on Quality of Multimedia Experience (QoMEX), 2020, pp. 1-6.
[19] J John G. Beerends, W. A. C. van den Brink, and B. Rodger, “The role of informational masking and perceptual streaming in the measurement of music codec quality,” in Audio Engineering Society Convention 100, Copenhagen, May 1996.
[20] Chi-Min Liu, Han-Wen Hsu, and Wen-Chieh Lee, “Compression artifacts in perceptual audio coding,” IEEE Transactions on Audio, Speech, and Language Processing, vol. 16, no. 4, pp. 681-695, 2008.
[21] ITU-R Rec. BS.1534, Method for the subjective assessment of intermediate quality levels of coding systems, Geneva, Switzerland, 2015.
[22] Jayme Garcia Arnal Barbedo and Amauri Lopes, “A new cognitive model for objective assessment of audio quality,” J. Audio Eng. Soc, vol. 53, no. 1/2, pp. 22-31, 2005.
[23] ITU-T Rec. P.863, Perceptual Objective Listening Quality Assessment, Geneva, Switzerland, 2014.
[24] Ted Painter and Andreas Spanias, “Perceptual coding of digital audio,” Proceedings of the IEEE, vol. 88, no. 4, pp. 451-515, 2000.
[25] John G. Beerends and Jan A. Stemerdink, “A perceptual audio quality measure based on a psychoacoustic sound representation,” J. Audio Eng. Soc, vol. 40, no. 12, pp. 963-978, 1992.
[26] Thomas Biberger, Jan-Hendrik Fleβner, Rainer Huber, and Stephan D Ewert, “An objective audio quality measure based on power and envelope power cues,” Journal of the Audio Engineering Society, vol. 66, no. 7/8, pp. 578-593, 2018.
[27] Steven van de Par, Sascha Disch, Andreas Niedermeier, Elena Burdiel Pérez, and Bernd Edler, “Temporal envelope-based psychoacoustic modelling for evaluating non-waveform preserving audio codecs,” in AES Convention, New York, 2019, p. 10314.
[28] Brian C J Moore, Brian R Glasberg, and Thomas Baer, “A model for the prediction of thresholds, loudness, and partial loudness,” Journal of the Audio Engineering Society, vol. 45, no. 4, pp. 224-240, 1997.
[29] Eberhard Zwicker, Richard Feldtkeller, and Richard Feldtkeller, “Das Ohr als Nachrichtenempfänger,” Monographien der elektrischen Nachrichtentechnik, 1967.
[30] Nathaniel I. Durlach, Christine R. Mason, Gerald Kidd, Tanya L. Arbogast, H. Steven Colburn, and Barbara G. Shinn-Cunningham, “Note on informational masking (I),” The Journal of the Acoustical Society of America, vol. 113, no. 6, pp. 2984-2987, 2003.
[31] Robert A Lutfi, “A model of auditory pattern analysis based on component-relative-entropy,” The Journal of the Acoustical Society of America, vol. 94, no. 2, pp. 748-758, 1993.
[32] ISO/IEC JTC1/SC29/WG11, “USAC verification test report N12232,” Tech. Rep., International Organisation for Standardisation, 2011.
[33] ITU-T Rec. P.1401, Methods, metrics and procedures for statistical evaluation, qualification and comparison of objective quality prediction models, Geneva, Switzerland, 2012.
[34] Stefan Meltzer and Moser Gerald, “MPEG-4 HE-AAC v2-audio coding for today's digital media world,” EBU Technical Review, pp. 1-12, 2006.
[35] Sascha Dick, Nadja Schinkel-Bielefeld, and Sascha Disch, “Generation and evaluation of isolated audio coding artifacts,” in Audio Engineering Society Convention 143, New York, October 2017.
[36] Albert S Bregman, Auditory scene analysis: The perceptual organization of sound, MIT press, 1994.

1. An apparatus for quality determination of an audio signal, wherein the apparatus comprises:
a perceptual model for receiving the audio signal and for determining distortion information for each of one or more distortion metrics, wherein each distortion metric of the one or more distortion metrics depends on a comparison between a feature of the audio signal and of a corresponding feature of reference information, and
a distortion-to-quality mapping module for determining a quality of the audio signal depending on the distortion information for each of the one or more distortion metrics and depending on information on one or more cognitive effects.

2. An apparatus according to claim 1,
wherein the one or more cognitive effects comprise at least one of informational masking information and perceptual streaming information, and
wherein the distortion-to-quality mapping module is configured to determine the quality of the audio signal depending on the distortion information for each of the one or more distortion metrics and depending on at least one of the informational masking information and the perceptual streaming information.

3. An apparatus according to claim 2,
wherein the one or more cognitive effects are two or more cognitive effects which comprise the informational masking information and the perceptual streaming information, and wherein the distortion-to-quality mapping module is configured to determine the quality of the audio signal depending on the distortion information for each of the one or more distortion metrics, depending on the informational masking information and depending on the perceptual streaming information; or
wherein the perceptual model is configured to determine the informational masking information depending on signal variations of the audio signal in a vicinity of a masking threshold.

4. An apparatus according to claim 2,
wherein the perceptual model is configured to determine the informational masking information and the perceptual streaming information depending on an excitation pattern of the audio signal and on an excitation pattern of the perceptual streaming information.

5. An apparatus according to claim 4,
wherein the perceptual model is configured to determine the informational masking information, such that the informational masking depends on a difference between an excitation pattern of the audio signal and an excitation pattern of the reference information; or
wherein the perceptual model is configured to determine the informational masking information, such that, for each time index of a plurality of time indices, for each frequency index of a plurality of frequency indices, the informational masking information depends on a difference between an excitation pattern of the audio signal for a time-frequency bin of said time index and of said frequency index and an excitation pattern of the reference information for said time-frequency bin.

6. An apparatus according to claim 4,
wherein the perceptual model is configured to determine the informational masking information by determining a variance of a term over a time window, wherein the term depends on a difference between an excitation pattern of the audio signal and an excitation pattern of the reference information.

7. An apparatus according to claim 4,
wherein the perceptual model is configured to determine the informational masking information by determining, for each frequency index of a plurality of frequency indices, a variance of a term over a time window, wherein, for each time index of all time indices of the time window, the term depends on a difference between an excitation pattern of the audio signal of a time-frequency bin of said time index and of said frequency index and an excitation pattern of the reference information for said time-frequency bin; or
wherein the perceptual model is configured to determine the informational masking information by summing the variance of the term of each frequency index of the plurality of frequency indices; or
wherein the time window exhibits a time duration, which is greater than or equal to 5 ms, and which is smaller than or equal to 800 ms; or
wherein the perceptual model is configured to determine the informational masking information, such that the informational masking information is defined depending on
$$\frac{1}{K} {\sum }_{1}^{K} var ( β ( n , k ) )$$
wherein β(n, k) indicates the term for a time-frequency bin (n, k) with time index n and frequency index k, wherein var(β(n, k)) indicates the variance of the term β(n, k) over the time window, and wherein K indicates a number of the plurality of frequency bins.

8. An apparatus according to claim 6,
wherein the term is defined depending on
$$β = {e}^{- α ( {E}_{T} - {E}_{R} ) / {E}_{ref}}$$
wherein E_{T} indicates the excitation pattern of the audio signal for a time-frequency bin,
wherein E_{R} indicates the excitation pattern of the reference signal for said time-frequency bin,
wherein E_{R} indicates an excitation pattern for a reference pattern for said time-frequency bin,
wherein α is a positive real value, e.g., indicating an amount of partial masking.

9. An apparatus according to claim 2,
wherein the one or more distortion metrics are a plurality of distortion metrics,
wherein the perceptual model is configured to determine the distortion information for each of the plurality of distortion metrics, wherein each distortion metric of the plurality of distortion metrics depends on a comparison between a feature of the audio signal and of a corresponding feature of the reference information, and
wherein the distortion-to-quality mapping module is configured to determine the quality of the audio signal depending on the distortion information for each of the plurality of distortion metrics, depending on the informational masking information and depending on the perceptual streaming information.

10. An apparatus according to claim 9,
wherein the perceptual model is configured to determine a distortion value as the distortion information for each of the plurality of distortion metrics,
wherein the perceptual model is configured to determine an informational masking value as the informational masking information,
wherein the perceptual model is configured to determine a perceptual streaming value as the perceptual streaming information, and
wherein the distortion-to-quality mapping module is configured to determine the quality of the audio signal depending on the distortion value for each of the plurality of distortion metrics, depending on the informational masking value and depending on the perceptual streaming value.

11. An apparatus according to claim 10,
wherein the distortion-to-quality mapping module is configured to determine the quality of the audio signal by determining a plurality of quality score values by determining, for each distortion metric of the plurality of distortion metrics, a quality score value of the plurality of quality score values, e.g., a MUSHRA score value, from the distortion value for said distortion metric using a distortion-to-quality mapping function of a plurality of distortion-to-quality mapping functions.

12. An apparatus according to claim 11,
wherein the distortion-to-quality mapping module is configured to determine the quality of the audio signal by applying the informational masking value or by applying a value derived from the informational masking value on the quality score value or on a value derived from the quality score value of one or more of the plurality of distortion metrics, and
wherein the distortion-to-quality mapping module is configured to determine the quality of the audio signal by applying the perceptual streaming value or by applying a value derived from the perceptual streaming value on the quality score value or on a value derived from the quality score value of at least one of the plurality of distortion metrics.

13. An apparatus according to claim 10,
wherein the distortion-to-quality mapping module is configured to determine the quality of the audio signal such that the quality of the audio signal depends on a linear combination of the distortion value for each of the plurality of distortion metrics, the informational masking value and the perceptual streaming value; or
wherein the apparatus is an apparatus according to claim 14, and the distortion-to-quality mapping module is configured to determine the quality of the audio signal such that the quality of the audio signal depends on a linear combination of the informational masking value and of the perceptual streaming value and of the plurality of quality score values that have been determined by the distortion-to-quality mapping module using the plurality of distortion-to-quality mapping functions.

14. An apparatus according to claim 9,
wherein the plurality of distortion metrics comprise at least two distortion metrics of:
a distortion metric indicating a band limitation of the audio signal (AvgLinDist),
a distortion metric indicating a temporal modulation of disturbances of the audio signal (RmsModDiff),
a distortion metric indicating an added noise in the audio signal (RmsNoiseLoud),
a distortion metric indicating missing spectro-temporal components in the audio signal (RmsMissingComponents),
a distortion metric indicating a harmonic structure of error of the audio signal (EHS),
a distortion metric indicating a at least one of noisiness and audibility of coding noise in the audio signal (Segmental NMR),
wherein the distortion-to-quality mapping module is configured to determine the quality of the audio signal depending on said at least two distortion metrics.

15. An apparatus according to claim 14,
wherein said at least two distortion metrics comprise the distortion metric indicating the harmonic structure of error of the audio signal (EHS) and the distortion metric indicating the at least one of noisiness and audibility of coding noise in the audio signal (Segmental NMR), and
wherein the distortion-to-quality mapping module is configured to determine the quality of the audio signal depending on the distortion metric indicating the harmonic structure of error of the audio signal (EHS) and depending on the distortion metric indicating the at least one of noisiness and audibility of coding noise in the audio signal (Segmental NMR).

16. An apparatus according to claim 15,
wherein said at least two distortion metrics further comprise the distortion metric indicating the band limitation of the audio signal (AvgLinDist),
wherein the distortion-to-quality mapping module is configured to determine the quality of the audio signal further depending on the distortion metric indicating the band limitation of the audio signal (AvgLinDist).

17. An apparatus according to claim 1,
wherein the reference information comprises information on a reference signal, and
wherein each distortion metric of the plurality of distortion metrics depends on a comparison between a feature of the audio signal and of a corresponding feature of the reference signal.

18. An apparatus according to claim 17,
wherein the reference signal is an original audio signal, and
wherein the audio signal is a decoded signal resulting from a decoding of an encoded audio signal, wherein the encoded audio signal encodes the original audio signal.

19. An apparatus according to claim 2,
wherein the reference information comprises information on a reference signal,
wherein each distortion metric of the plurality of distortion metrics depends on a comparison between a feature of the audio signal and of a corresponding feature of the reference signal,
wherein the perceptual model comprises a psychoacoustic model and a multi-dimensional comparison unit,
wherein the psychoacoustic model is configured to receive the audio signal, to conduct a time-frequency decomposition of the audio signal to acquire a plurality of time-frequency components of the audio signal, and to determine a plurality of excitation patterns of the audio signal from the plurality of time-frequency components of the audio signal,
wherein the psychoacoustic model is configured to receive the reference signal, to conduct a time-frequency decomposition of the reference signal to acquire a plurality of time-frequency components of the reference signal, and to determine a plurality of excitation patterns of the reference signal from the plurality of time-frequency components of the reference signal,
wherein the multi-dimensional comparison unit is configured to extract a plurality of features of the audio signal from the plurality of excitation patterns of the audio signal,
wherein the multi-dimensional comparison unit is configured to extract a plurality of features of the reference signal from the plurality of excitation patterns of the reference signal,
wherein the one or more distortion metrics are a plurality of distortion metrics, and
wherein, for determining the distortion information for each distortion metric of the plurality of distortion metrics, the multi-dimensional comparison unit is configured to conduct one or more comparisons depending on one or more of the plurality of features of the audio signal and depending on one or more of the plurality of features of the reference signal and depending on said distortion metric,
wherein the distortion-to-quality mapping module is configured to determine the quality of the audio signal depending on the distortion information for each of the plurality of distortion metrics, depending on the informational masking information and depending on the perceptual streaming information.

20. An apparatus according to claim 1,
wherein the reference information comprises a plurality of parameters which depends on a listener preference.

21. An apparatus according to claim 2,
wherein the informational masking information indicates a degree of decrease in the audibility of distortions of the audio signal caused by rapid fluctuations of the audio signal in time; or
wherein the perceptual streaming information indicates a degree of signal disturbances of the audio signal that form a separate percept from the audio signal compared to distortions that form a single percept with the audio signal.

22. An apparatus according to claim 1,
wherein the a distortion-to-quality mapping module is implemented as a cognitive salience model; or
wherein the distortion-to-quality mapping module is implemented as a multivariate-regression.

23. An apparatus according to claim 16,
wherein the apparatus implements an audio encoder for encoding an audio signal,
wherein the apparatus is configured to receive an original signal as the reference signal, wherein the decoded signal results from a decoding of an encoded audio signal, wherein the encoded audio signal encodes the original audio signal, and
wherein the audio encoder is configured to determine one or more coding parameters depending on a quality of the decoded audio signal.

24. The audio encoder according to claim 23,
wherein the audio encoder is configured to encode, depending on the quality of the decoded audio signal, one or more bandwidth extension parameters which define a processing rule to be used at a side of an audio decoder to derive a missing audio content on the basis of an audio content of a different frequency range encoded by the audio encoder; or
wherein the audio encoder is configured to encode, depending on the quality of the decoded audio signal, one or more audio decoder configuration parameters which define a processing rule to be used at the side of an audio decoder; or
wherein the audio encoder is configured to support an Intelligent Gap Filling, and
wherein the audio encoder is configured to determine one or more parameters of the Intelligent Gap Filling using a determination of the quality of the decoded audio signal; or
wherein the audio encoder is configured to select one or more associations between a source frequency range and a target frequency range for a bandwidth extension or one or more processing operation parameters for a bandwidth extension depending on the quality of the decoded audio signal; or
wherein the audio encoder is configured to select one or more associations between a source frequency range and a target frequency range for a bandwidth extension, wherein the audio encoder is configured to selectively allow or prohibit a change of an association between a source frequency range and a target frequency range depending on an evaluation of a modulation of an envelope in an old or a new target frequency range.

25. A method for quality determination of an audio signal, wherein the method comprises:
receiving the audio signal and determining distortion information for each of one or more distortion metrics, wherein each distortion metric of the one or more distortion metrics depends on a comparison between a feature of the audio signal and of a corresponding feature of reference information, and
determining a quality of the audio signal depending on the distortion information for each of the one or more distortion metrics and depending on information on one or more cognitive effects.

26. A method for audio encoding according to claim 25,
wherein the quality determination of the audio signal is conducted by determining a quality of a decoded signal,
wherein the reference information comprises information on a reference signal, wherein each distortion metric of the plurality of distortion metrics depends on a comparison between a feature of the audio signal and of a corresponding feature of the reference signal, wherein the reference signal is an original audio signal, and wherein the audio signal is a decoded signal resulting from a decoding of an encoded audio signal, wherein the encoded audio signal encodes the original audio signal,
wherein the method comprises receiving an original signal as the reference signal, wherein the decoded signal results from a decoding of an encoded audio signal, wherein the encoded audio signal encodes the original audio signal, and
wherein the method comprises determining one or more coding parameters depending on a quality of the decoded audio signal.

27. A non-transitory digital storage medium having a computer program stored thereon to perform the method for quality determination of an audio signal, wherein the method comprises:
receiving the audio signal and determining distortion information for each of one or more distortion metrics, wherein each distortion metric of the one or more distortion metrics depends on a comparison between a feature of the audio signal and of a corresponding feature of reference information, and
determining a quality of the audio signal depending on the distortion information for each of the one or more distortion metrics and depending on information on one or more cognitive effects,
when said computer program is run by a computer.
